(19) United States
(12) Patent Application Publication
(10) Pub. No.: US 2024/0372277 A1
(43) Pub. Date: Nov. 7, 2024

(54) CHARGING SOCKET, CONNECTING PART AND SYSTEM FOR HIGH VOLTAGE APPLICATIONS

(71) Applicant: Auto-Kabel Management GmbH, Hausen i.W. (DE)

(72) Inventors: Matthias Weinbrich, Dorsten (DE); Gordon Kraft, Viersen (DE)

(21) Appl. No.: 18/689,238

(22) PCT Filed: Aug. 16, 2022
(86) PCT No.: PCT/EP2022/072831

§ 371 Date: Mar. 5, 2024

(30) Foreign Application Priority Data
Sep. 10, 2021 (DE) 10 2021 123 487.5

(51) Int. Cl. H01R 4/50; B60L 53/16

(52) U.S. Cl. CPC H01R 4/5016; B60L 53/16

(57) ABSTRACT

The invention relates to a charging socket with a connecting part, in particular for use in electromobility, wherein a plug-in bolt arranged in the charging socket has at least one recess in which a connecting key bolt of the connecting part engages.

The subject matter of the invention relates to a charging socket for electric vehicles, a corresponding connecting part, and a system comprising a charging socket and a connecting part.

One of the challenges of large-scale electrification of automobility is to minimize the charging times of the energy storage systems involved. The tank of a conventional vehicle with an internal combustion engine is filled within a few minutes with fuel which contains enough energy for hundreds of kilometers of driving distance. In contrast, electrically powered vehicles usually require a high-capacity electric battery to be charged. In order to charge the battery as quickly as possible, preferably significantly faster than it is subsequently discharged during driving operation, high charging powers are used with high currents and/or voltages.

In order to transmit the necessary high charging power, e.g. from a charging station to the vehicle battery, the entire transmission path from the charging station socket to the vehicle's charging socket to the accumulator must have very good electrical conductivity. In particular, all transitions between the individual components of the transmission path must have particularly low transition resistances.

Another challenge relates to the temperature management and thus the absorption and dissipation of heat caused by Joule losses during the charging process.

The object of the invention was thus, inter alia, to provide a charging socket and a connecting part which are distinguished by particularly good electrical current and heat, a high heat capacity and a high heat dissipation.

The object is achieved by a charging socket according to claim 1, a connecting part according to claim 2, and a system according to claim 21.

The charging socket according to the invention comprises a front side and a rear side facing away from the front side. Both the front side and back side can be assigned to surfaces of the charging socket. Both the front side and the rear side of the charging socket can also be defined separately from structural units of the charging socket.

The charging socket according to the invention comprises at least one receptacle for a charging plug. This charging plug can come from a charging station, for example. This can be a mode 2, mode 3, type 1 or type 2 plug, for example. In particular, the plug can have connections for charging via direct current. For example, the plug can be a Combined Charging System (CCS), CHAdeMO, a Tesla® Supercharger plug, or some other plug with direct current contacts.

The charging socket can comprise a housing. The housing of the charging socket can be made of a non-conductive material, for example plastic, such as high-temperature plastic, for example PA6GF15, UL94 or another plastic that is suitable for high temperatures. Materials such as ceramics, glass or the like are also possible.

Fastening means can be provided on the housing, for example force-fit and/or form-fit fastening means, for example holes for screws, snap elements, hooks or similar fastening means. The fastening means can be used to attach the charging socket to a vehicle, in particular to an electric vehicle.

The receptacle for the charging plug comprises, for example, a recess in the charging socket, in particular in the housing of the charging socket, into which the charging plug can be plugged. The receptacle can be adapted to the cross section of a charging plug. A closure may also be provided on the receptacle, in particular a closure that can be opened. For example, a flap can close the receptacle for the charging plug. For example, the closure can close automatically, for example in a spring-loaded manner, so that the receptacle is closed without charging plug being plugged in.

In some embodiments, the receptacle may have a rear wall. The rear wall can limit the receptacle towards the housing in the direction in which the charging plug is inserted. At least one opening can be provided in the receptacle, in particular in the housing of the receptacle, in particular in the rear wall. For example, the opening may have a seal, in particular a circumferential seal. The seal can ensure that the transition between the element guided through the opening, for example a bolt or other element, and the opening is gas-, liquid-, and/or pressure-tight. In particular, two openings can also be provided.

At least one plug-in bolt can be arranged at least partially in the receptacle. For example, the plug-in bolt can be arranged in a plug connector. Parts of the plug connector can, for example, at least partially enclose the plug-in bolt.

At least parts of the at least one plug-in bolt are arranged in the receptacle. The plug-in bolt can serve, for example, as a contact pin for the charging socket and/or a charging plug. The charging plug can make contact with at least one of the at least one plug-in bolts when it is inserted into the receptacle. For example, the plug-in bolt can serve as a contact pin for, for example, a control line, alternating current line, direct current line, or another type of line.

The receptacle, in particular the shape of the housing and/or the arrangement of the at least one plug-in bolt, can be adapted to a plug face of the charging plug. The receptacle can be suitable for a particular type of charging plug.

The plug-in bolts are made of a conductive material. In particular, the plug-in bolts can be formed from a metallic material. For example, a plug-in bolt can be formed at least partially from copper, aluminum, iron, gold, silver, or other metal materials and/or alloys thereof.

It can be advantageous to plate plug-in bolts at least partially. In particular, a metallic plating can be advantageous, for example to prevent contact corrosion, reduce contact resistance and/or give the connector a longer useful life. For example, a plug-in bolt can be plated with silver, gold, copper, aluminum, nickel, and/or further metals and/or alloys thereof. The plating can substantially completely cover the plug-in bolt or be attached only to selected regions. For example, a plating can be applied in the receptacle and/or on the second region of the plug-in bolt. It is also possible to provide a plug-in bolt with a double plating, for example an inner nickel layer and an outer silver layer.

In a preferred embodiment, at least one plug-in bolt is formed from copper, in particular E-copper. The copper can be plated with silver, in particular with silver over a nickel plating.

The plug-in bolt according to the invention comprises at least two mutually opposite end faces. These can be substantially flat. It is also possible for the surface of the end faces to deviate from a flat shape, for example a rounded shape, a pointed shape, in particular a cone-shaped, stepped and/or saddle roof-shaped pointing or another surface shape of the end faces.

Starting from the first end face, a first region of the plug-bolt extends to a central region of the plug-in bolt. Starting from the second end face, which is opposite the first end face, a second region extends to the central region of the plug-in bolt.

In the charging socket, the plug-in bolt extends from the rear side of the charging socket into the receptacle for the charging plug. In particular, the first region extends starting from the rear side in the direction of the receptacle. The second region extends at least partially into the receptacle. In particular, the second region can thus serve at least partially as a contact pin for a charging plug.

The central region can have an extension in the longitudinal direction of the plug-in bolt. The central region can comprise parts of the first and/or the second region. The central region can also define a further region of the plug-in bolt that is different from the first and second regions. The central region can substantially lie halfway along the length of the plug-in bolt along the longitudinal axis. The central region can also be arranged further away from one of the end faces than from the other end face.

The cross section of the first region can be greater than the cross section of the second region. Both regions can also have a substantially identical cross section.

In addition to the first end face, the first region of the plug-in bolt can have a further end face. This further end face can be oriented substantially away from the first end face. The further end face points in the direction of the second region. The further end face can be substantially flat. It is also possible to have a surface of the further end face that deviates from a flat shape, for example a rounded shape, a pointed shape, in particular a saddle roof-shaped pointing or another surface shape of the further end face.

The cross section of a plug-in bolt here has to be determined substantially perpendicular to the longitudinal extension of the plug-in bolt. A larger cross-section is associated with an increased material volume, among other things, and thus with an increased heat capacity of the plug-in bolt.

If a first cross section is specified as being larger than a second cross section, in the present application this can mean that the cross-sectional area of the first cross section is larger than the cross-sectional area of the second cross section. It can also mean that the first cross section has a larger diameter in at least one direction than the second cross section. It can also mean that the first cross section can completely envelop the second cross section.

A plug-in direction can be defined for a plug-in bolt. This direction can in particular be defined substantially parallel to the longitudinal axis of the plug-in bolt and can extend from the first region to the second region of the plug-in bolt.

A recess is arranged in the first end face of the plug-in bolt. The recess can be suitable for accommodating a connecting key bolt. The recess can extend parallel to the longitudinal axis of the plug-in bolt in the direction of the central region of the plug-in bolt. The recess can have a substantially round cross section; but the cross section can also be elliptical, angular, in particular triangular, quadrangular, pentagonal or polygonal, or otherwise shaped differently from a round shape.

The cross section of the recess can be substantially constant along the longitudinal axis of the plug-in bolt. The cross section can also taper, in particular along the longitudinal axis in the direction of the central region of the plug-in bolt, in particular linearly, so that the cross section decreases linearly with increasing penetration depth of the recess into the first region of the plug-in bolt. The cross section of a recess can decrease evenly on all sides perpendicular to the direction of extension of the recess, for example perpendicular to the longitudinal axis of the plug-in bolt. The cross section can also decrease more strongly in a direction perpendicular to the longitudinal axis than in another direction. In particular, an asymmetry of the recess can be achieved in this manner, which allows the insertion of a correspondingly shaped bolt only in an angular position about the longitudinal axis.

In a preferred embodiment, the recess is conically shaped.

This recess can also be defined as belonging to the charging socket.

A blind hole can be provided in the recess of at least one of the plug-in bolts. In particular, a thread can be provided in the blind hole. The blind hole can end in the first region of the plug-in bolt. In some cases, it is also possible for the blind hole to protrude into the second region. The blind hole, especially with a thread, enables a connecting key bolt to be firmly screwed into the recess. A high contact pressure can be achieved between the connecting key bolt and the recess. A particularly low-resistance transition between a connecting key bolt and the plug-in bolt can thus be produced.

In particular in combination with a tapered, in particular conical recess, a connecting key bolt, which is also tapered and in particular conical, can be permanently connected in the recess by means of the thread in the blind hole and a screw in a firm and well-conducting manner.

A further aspect is a connecting part. This can be a part of the charging socket or can stand alone.

The connection part can be arranged on the rear side of the charging socket, for example. The connecting part can also be arranged at least partially inside the charging socket. The connecting part is also inventive in its own right and can also be used independently of the charging socket.

The connecting part according to the invention comprises at least one busbar. In particular, the busbar has a substantially rectangular cross section. The cross section may have two wide sides that are opposite and substantially parallel to one another and two narrow sides that are substantially perpendicular to one another and substantially parallel and opposite to one another. The busbar has at least partially a longitudinal axis which is substantially perpendicular to both the narrow and wide sides. The wide side is wider perpendicular to the longitudinal axis than the narrow side.

If the busbar is cut to length, an end face can also be defined to which the longitudinal axis of the busbar can substantially form the surface normal.

The busbar is made of an electrically conductive material and can be made of a metal material, for example. The busbar can be made of copper, aluminum, alloys thereof, and/or other metal materials.

In particular, the busbar can be at least partially insulated. For this purpose, the busbar is plated, for example, with a layer of a non-conductive material, such as a plastics material. A lacquer coating or a similar electrically non-conductive plating is also possible.

The busbar can be at least partially plated with a conductive plating, for example with a metal material, in particular with silver, gold, nickel, and/or alloys thereof, and/or multilayer arrangements of combinations of these metal materials, for example as a silver plating over a nickel plating.

The use of a busbar has the advantage that it provides good conductivity for heat and electrical current due to its solid design with a large cross section. In addition, the heat capacity is also high, due in particular to the volume. Due to the increased surface area compared to round conductors with the same cross-sectional area, more heat can also be radiated via the surface.

A connecting key bolt is arranged on the busbar. The connecting key bolt has a joining region extending from a first end face to a central region, and a contact region extending from a second end face to the central region.

The connecting key bolt is made of an electrically conductive material. In particular, the connecting key bolt can be formed from a metal material, in particular copper, aluminum, alloys thereof, and/or other metal materials. An at least partially or even complete plating of the connecting key bolt is also possible. For example, the connecting key bolt can be plated with silver, gold, nickel, and/or alloys, and/or combinations thereof. In particular, the connecting key bolt can be formed from copper, in particular E-copper, and can be provided at least partially, in particular substantially completely, with a silver plating over a nickel plating.

A longitudinal axis of the connecting key bolt can also be defined, which extends, for example, along the axis of the largest spatial extension of the connecting key bolt. A connection direction can also be defined from the joining region to the contact region. This direction can run parallel to the longitudinal axis.

In particular, the connecting key bolt can be arranged in an opening of the busbar. In particular, the opening of the busbar extends from a first wide side to the second wide side of the busbar opposite the first wide side. The opening can also be one-sided, so that it is only accessible from a first wide side.

The connecting key bolt can be connected to the busbar in a material-fit manner. Other types of connection are possible, for example a force-fit and/or form-fit connection. However, a material-fit connection is advantageous in terms of electrical and thermal conductivity between the connection pin and busbar.

For example, the connecting key bolt can be welded to the busbar, in particular by means of a friction welding process, in particular by means of rotary friction welding.

In particular, the connecting key bolt can be divided into two regions. A joining region is connected to the busbar in the opening, in particular in a material-fit manner. In particular, inter alia, the lateral surface of the joining region can be connected to the inner surface of the opening of the busbar in a material-fit manner.

The connecting key bolt also has a contact region. In a connecting part according to the invention, this region preferably protrudes beyond a wide side of the busbar in the connection direction. The contact region can be at least partially connected to the busbar. In particular, the contact region rests on the busbar. The contact region can be connected to the busbar in a material-fit manner.

The contact region of the connecting key bolt points away from the busbar, in particular in the connection direction.

In particular, the contact region can be tapered, particularly with increasing distance from the busbar. In particular, an end face can be provided on the contact region of the connecting key bolt, which end face points away from the busbar. The connecting key bolt, in particular the contact region of the connecting key bolt, can be tapered toward the end face. In particular, the contact region can be conically tapered.

The joining region and/or the contact region can at least partially have a substantially round cross section. The joining region and/or the contact region can also have a cross section that deviates from a round shape. For example, at least one of the regions may at least partially have a cross section that is substantially oval, angular, in particular triangular, quadrangular, pentagonal or polygonal, star-shaped, or that otherwise deviates from a round shape.

The busbar can be made of an electrically conductive material that is suitable for high-voltage applications and/or for carrying high direct currents. In particular, the busbar can be made of aluminum, in particular soft-annealed aluminum. Aluminum is lightweight, which is of great advantage for use in vehicles. In addition, aluminum is cheaper than copper. The busbar can also be made of a different material, in particular a different metal material, such as copper.

The opening of the busbar in which the connecting key bolt, in particular the joining region of the connecting key bolt, is at least partially arranged can be shaped as a through-hole, for example. The through-hole can have a substantially round cross section. An elliptical, angular, in particular triangular, square, pentagonal, hexagonal, polygonal, serrated or otherwise shaped cross section of the through-hole is also possible. The through-hole can have a substantially constant cross section along the thickness of the busbar, or also a variable cross section. For example, the through-hole can taper toward or away from the contact region of the connecting key bolt.

The busbar can be insulated. In particular, an insulation layer can be applied to the busbar. The insulation layer can substantially completely surround the busbar, except for regions in which taps from the busbar are provided. For example, the busbar can be free of insulation, i.e. stripped, in the region of the connecting key bolt. Stripped here does not necessarily mean that there was already insulation, which was removed, on the busbar. It is also possible that the busbar was not previously insulated in the stripped region.

The region of the busbar in which the connecting key bolt is connected thereto can in particular be an end region of the busbar. This end region can be stripped. A center tap is also possible. In this case, the busbar can be stripped in the region of the connecting key bolt and surrounded by an insulation at one or both sides of the connecting key bolt.

In an end region, which can be located in particular in the region of the connecting key bolt, the busbar can have at least one rounded corner. Here a corner can be a corner between the edge between the narrow side and the wide side and the edge between the wide side and the front edge. Both end corners, which can be seen in a plan view of one of the two wide sides of the busbar, can also be rounded. Alternatively or additionally, the four corners of the end region, each of which forms a connection point between a wide side, a narrow side and the end face on the end side of the busbar, can be rounded.

The busbar can have a cross section of at least 50 mm², preferably between 100 and 300 mm². Larger cross sections are also possible if a particularly high electrical power and/or a particularly large amount of heat needs to be transported.

The busbar may have a side recess, in addition to the opening in which the connecting key bolt is at least partially arranged. This side recess can be arranged on one side of the busbar, so that the side recess interrupts the otherwise largely straight course of the longitudinal edge. Here and in the following, the longitudinal edge can be defined as the edge at which a wide side and a narrow side of the busbar meet. In particular, the side recess can be shaped as a notch. In a plan view of the wide side, the edge of the side recess can extend, at least on one side of the side recess, substantially perpendicular from the longitudinal edge into the busbar. Both sides of the side recess can also extend substantially perpendicularly into the busbar. Other edge courses of at least one side of the side recess are also possible. The side recess can thus have one or two edges which are inclined in relation to the narrow side when viewed in plan view. For example, at least one edge of the side recess can extend from the narrow side at an angle of 30-60°. In particular, one edge can extend essentially perpendicular and the other at an angle to the longitudinal edge. The side recess can be shaped in such a way that it forms a hook and/or an undercut of the longitudinal edge of the busbar.

The side recess can be substantially rectangular in shape, for example square. The side recess may also be rounded; for example, it can be substantially semicircular in shape. The side recess can also be shaped as a quarter circle.

A side recess can be used to lock the busbar in a holder provided for this purpose. This allows a latching element to engage in the recess. An element that is movable in another way, for example a latching element and/or a screw element or the like, can also engage in the side recess. Alternatively or additionally, the busbar can be encapsulated by a retaining element, for example made of plastics material. The retaining element can engage in the side recess. In all these cases, the side recess provides the busbar with a better grip in relation to its immediate surroundings. In particular, in this way the position of the busbar and in particular that of the connecting key bolt can be clearly determined by latching in a position defined by the holder even before contacting the connecting key bolt with elements provided for this purpose, in particular in the receptacle of the charging socket. In this way, the assembly of the connection element is significantly simplified.

The connecting key bolt can be arranged centrally on the wide side of the busbar in relation to the central axis of the wide side of the busbar. In the case of a plan view of the wide side, the central axis can extend centrally in the wide side along the longitudinal direction of the busbar, so that it is at substantially the same distance from both narrow sides. The connecting key bolt can also be arranged decentrally in relation to the center axis of the busbar. At least the joining region of the connecting key bolt can be located within the wide side of the busbar in a plan view of the wide side of the busbar. This joining region is preferably surrounded circumferentially by the inner lateral surface of the opening in the busbar and/or contacts it at least partially. The contact region of the connecting key bolt can protrude beyond the wide side of the busbar in a plan view of the broadside. In an advantageous embodiment, the contact region is also located completely within the wide side in the plan view of the wide side.

If the busbar has a side recess, the connecting key bolt and the side recess can be offset relative to one another along the longitudinal axis of the busbar. If the connecting key bolt is arranged in an end region of the busbar, the connecting key bolt can be offset, for example, in the direction of the end of the busbar relative to the side recess. The connecting key bolt can also be spaced apart from the side recess along the longitudinal axis of the busbar from the end of the busbar. Spacing along the longitudinal axis increases the mechanical stability of the busbar, as the narrowing of the busbar due to the opening and the side recess are not directly adjacent to one another and therefore do not culminate in a combined narrowing. The busbar can also heat up considerably, in particular in the immediate vicinity of the connecting key bolt, so that a particularly large amount of heat capacity is required there. For this reason, it is advantageous to distance the side recess from the connecting key bolt. The holder, which can engage in the side recess, can also be protected from heat by a spacing it from the connecting key bolt.

The side recess and the connecting key bolt can also be substantially at the same height along the longitudinal axis of the busbar.

The connecting key bolt can have a hole, for example a blind hole, in particular a through-hole along the longitudinal axis of the connecting key bolt. The through-hole can be arranged centrally in the connecting key bolt. In the connected state, the through-hole can be aligned substantially parallel to the surface normal on the wide side of the busbar between the connecting key bolt and the busbar.

The through-hole of the connecting key bolt can substantially have a round cross section. The through-hole of the connecting key bolt can also at least partially have a cross section that is substantially oval, angular, in particular triangular, quadrangular, pentagonal or polygonal, star-shaped, or that otherwise deviates from a round shape. A cross section deviating from a round shape enables, for example, a friction welding tool to transmit a torque to the connecting key bolt.

The cross section of the through-hole can be substantially constant along the longitudinal axis of the connecting key bolt. The cross section can also vary along the longitudinal axis. For example, the through-hole may have a smaller cross section in a region close to the contact region than in a region remote from the contact region, wherein in particular the regions of different through-hole cross sections extend to the corresponding end faces of the joining region and contact region.

The through-hole can be suitable for passing a screw through. In one embodiment, a screw can be arranged in the through-hole. For example, the screw can be arranged in the through-hole in captive manner, for example by inserting the screw into the through-hole starting from the joining region and inserting a blocking element that can be clamped onto the screw starting from the contact region, for example a locking washer or a plastic washer with latching tabs. Compared to the rest of the connecting key bolt, an enlarged cross-section of the through-opening in a region close to the end face of the contact region can have an advantageous effect.

The lateral surface of the joining region of the connecting key bolt can be substantially cylindrical in shape.

The lateral surface of the joining region of the connecting key bolt can be at least partially connected to an inner lateral surface of the opening of the busbar in a material-fit manner. This connection can be achieved in particular during welding, in particular during friction welding, in particular during rotary friction welding.

The lateral surface of the contact region of the connecting key bolt can taper, in particular such that the cross section decreases with increasing distance from the busbar. In particular, the lateral surface of the connecting key bolt, in particular of the contact region of the connecting key bolt, can be at least partially conical in shape.

The shape of the lateral surface of the contact region can be at least partially adapted to the shape of the recess in the first end face of the plug-in bolt of the charging socket. In particular, both can be conical in shape, in particular with an equal degree of tapering, so that the lateral surface of the contact region can rest substantially full-surface against the inner surface of the recess, and/or, in a connected state, rests against the connecting part and the charging socket.

In an advantageous embodiment, the recess and/or the connecting key bolt, in particular the contact region of the connecting key bolt, is dimensioned in such a way that when the lateral surfaces of the recess and the connecting key bolt are in contact with each other, a distance remains between the end face of the contact region and the part of the recess opposite it. This ensures that, in the event of a screw connection of the connecting key bolt with the recess, the entire contact pressure is absorbed by the lateral surfaces. The connecting key bolt can thus also penetrate sufficiently deeply into the recess so that the lateral surfaces contact each other substantially over the entire surface.

The joining region of the connecting key bolt can have a smaller diameter than the opening of the busbar in which the connecting key bolt is arranged. The two diameters can also be approximately the same size, so that there is sufficient friction during friction welding. The cross section of the joining region of the connecting key bolt can increase at least slightly towards the contact region so that the end face on the side of the joining region can only be partially countersunk into the opening in the busbar before welding without deformation. The diameter of the joining region is therefore at least partially greater than the diameter of the opening of the busbar, in particular in a section of the joining region facing the contact region, and/or at least partially smaller than the diameter of the opening, in particular in a portion of the joining region facing away from the contact region. To complete the connection, welding energy can be introduced into the connection between the connecting key bolt and the busbar, in particular by means of rotary friction welding, so that parts of the busbar and/or parts of the connecting key bolt plasticize. The connecting key bolt can then penetrate into the busbar to the desired depth. In particular, the connecting key bolt can penetrate, radially to the longitudinal axis of the connecting key bolt, at least partially into the inner lateral surfaces of the opening of the busbar and/or be connected thereto in a material-fit manner.

The contact region of the connecting key bolt can at least partially have a larger cross section than the opening of the busbar. In particular in the region of the transition between the joining region and the contact region of the connecting key bolt, the contact region of the connecting key bolt can have a larger cross section than the opening.

The connecting key bolt can alternatively or additionally have a collar. The collar can protrude beyond the joining region substantially perpendicular to the longitudinal axis of the connecting key bolt, in particular around the entire circumference of the connecting key bolt. Optionally, the collar can also protrude radially beyond the contact region, in particular around the entire circumference of the connecting key bolt. The collar can have a round cross section at least in portions along the longitudinal axis. The collar of the connecting key bolt can also at least partially have a cross section perpendicular to the cross section of the longitudinal axis which cross section is substantially oval, angular, in particular triangular, quadrangular, pentagonal or polygonal, star-shaped, or otherwise deviates from a round shape. A cross section of the collar deviating from a round shape can enable, for example, a friction welding tool to transmit a torque to the connecting key bolt via the collar.

The collar can be connected to the busbar in a material-fit manner. In particular, the connecting key bolt can be connected to the busbar with the collar alone or with the joining region in a material-fit manner.

The joining region can have a length that is greater than the thickness of the busbar. In particular, it is thus possible to achieve that, when connected, the connecting key bolt, in particular the joining region of the connecting key bolt, protrudes from the opening of the busbar along the longitudinal axis of the connecting key bolt and/or along the surface normal on the wide side of the busbar facing away from the contact region. The connecting key bolt protrudes beyond the busbar in the direction of the surface normal on the wide side, i.e. on one side with the contact region and on the other side of the busbar with the joining region extending through the opening.

The technical effect of such a protrusion on both sides can be achieved in particular in combination with a through-hole of the connecting key bolt. In particular if a screw is passed through the through-hole, by means of which the connecting key bolt is fastened to a further element, in particular in the recess of the charging socket. In this case, the contact pressure of the screw on the connecting part is substantially completely absorbed by the connecting key bolt and not substantially by the busbar. This has the advantage, in particular with busbars made of relatively soft materials such as aluminum, that the screw connection holds permanently and does not gradually lose contact pressure due to creep processes in the material of the busbar. For this purpose, the connecting key bolt can be made of a material such as copper, which is far less prone to deformation under permanent force than is aluminum, for example.

Advantageously, the contact region of the connecting key bolt is tapered in such a way that the lateral surfaces—the outer surface of the contact region of the connecting key bolt and the inner surface of the recess—rest against one another, in particular rest substantially full-surface against one another. The contact region of the connecting key bolt can therefore be adapted to a recess. This minimizes the contact resistance between the charging socket and the connection part. In particular, the lateral surfaces can have substantially the same degree of taper. This can mean that in a side view, perpendicular to the longitudinal axis of the connecting key bolt and/or the recess, the angle between this longitudinal axis and each of the lateral surfaces is substantially the same.

In particular, the inner lateral surface of the recess of the charging socket and/or the lateral surface of the contact region can be conically shaped. In particular, in such a way that the lateral surfaces can rest substantially full-surface against one another.

The connecting key bolt can be arranged in the recess. In particular, it can be connected to the recess in a force-fit and/or form-fit manner. In particular, a screw can be passed through the connecting key bolt, screwed into the blind hole of the receptacle, and can thus hold the connecting key bolt in the receptacle.

The at least one plug-in bolt of the charging socket which comprises the recess can be arranged in a plug connector. For this purpose, the charging socket can have a second receptacle, which can in particular be arranged on the rear side of the charging socket. The second receptacle can be suitable for inserting the plug connector. The second receptacle can comprise a recess in the charging socket, in particular in the housing of the charging socket. In particular, the second receptacle can be at least partially substantially cross-sectionally adapted to a plug connector.

Some further properties of the charging socket are explained below. In particular, this socket can comprise a plug connector in which at least one, preferably two or more, plug-in bolts are arranged.

A collar can be arranged on the rear side of the charging socket. For example, this collar can protrude beyond the wall of the housing in the direction of the rear side.

The charging socket can also comprise a bearing surface for the plug connector. The plug connector can rest at least partially on the bearing surface. The bearing surface can be arranged on the housing of the charging socket, for example. The bearing surface can, for example, be arranged circumferentially around the plug-in bolts and/or around the second receptacle. The bearing surface can also be arranged at least partially on the collar.

Retaining means for the plug connector can be provided on the charging socket, for example form-fit and/or force-fit retaining means, for example hooks, threads for screws, in particular threads embedded in the housing of the charging socket, in particular made of a metal material, or similar retaining means. The retaining means can in particular be arranged in the region of the second receptacle. The retaining means can be used to connect a plug connector to the charging socket. For example, this connector can be fastened to the charging socket by means of at least one, preferably two, three, or four or more screws.

The plug connector can be connected to the charging socket in a force-fitting and/or form-fitting manner.

At least one seal can be arranged on at least parts of the second receptacle and/or the bearing surface. For example, the seal can be arranged in a closed shape, for example in a ring, rectangle, oval, or other closed shape, on the second receptacle and/or the bearing surface. The seal can enclose at least part of the second receptacle. The seal can be manufactured for example from an elastic material, in particular from a plastics material, rubber, silicone, or similar materials.

The plug connector according to the invention comprises a housing. The housing can be made of a non-conductive material. For example, the housing can be molded from a plastics material, in particular from a plastics material which is suitable for high temperatures and/or has a high thermal conductivity. For example, polyamidimide, polysulfone, polyethersulfone, PA6GF15, UL94, or a similar heat-resistant plastics material can be used. The housing can also be formed from other non-conductive materials, such as ceramics or glass.

The housing of the plug connector can be formed in one piece, for example cast and/or injection-molded. It is also possible for the housing to be constructed from a plurality of parts. The individual parts can, for example, be screwed, glued, welded, or fastened to one another in some other way, and/or to the further elements of the plug connector described below.

The plug connector can comprise a single plug-in bolt. The plug connector can also comprise at least two plug-in bolts.

The at least two plug-in bolts can be arranged substantially parallel to one another in the plug connector. The plug-in directions of the at least two plug-in bolts can point in the same direction.

The plug-in bolts of the plug connector can be fixed in the housing. In particular, the plug-in bolts can be fixed in such a way that the longitudinal axes of at least two plug-in bolts are substantially parallel to one another. The housing can fix the plug-in bolts in such a way that they cannot move relative to one another without damaging the housing.

The housing can at least partially enclose the plug-in bolts. Preferably, surfaces of the plug-in bolts which are used for contacting other conductive elements remain free of housing parts.

A central axis can be defined for the first region of the plug-in bolt according to the invention. This axis can extend, for example, parallel to the longitudinal axis of the plug-in bolt. In particular, the central axis can extend through a center and/or near to a center of at least a part of the cross sections of the first region. The cross section here is a section perpendicular to the longitudinal axis of the plug-in bolt and/or perpendicular to the longitudinal axis of the corresponding region of the plug-in bolt whose cross section is being determined. For example, the center of the cross section can be defined as the geometric center of mass of the cross section.

A central axis can also be defined for the second region which, for example, likewise extends parallel to the longitudinal axis of the plug-in bolt and centrally in at least part of the cross sections of the second region.

The second region can be connected centrally to the first region. For example, the central axes of the first region and the second region can substantially coincide with one another. The second region can also be arranged eccentrically on the first region. This can mean, for example, that the central axis of the second region is spaced apart from the central axis of the first region, in particular perpendicular to the central axis of at least one of the regions and/or perpendicular to the longitudinal axis of the plug-in bolt and/or one of the regions of the plug-in bolt.

In this way, it is possible for the central axes of the first regions to be further away from one another than the central axes of the second regions. The central axes of the second regions can also be further apart from one another than the central axes of the first regions.

A distance between two axes, in particular central axes, can be defined here as the shortest possible connection between the two axes.

The central axes of the second regions of at least two plug-in bolts can both be spaced apart from the central axis of the first region. It is also possible for only the second region of one of the plug-in bolts to be arranged eccentrically on the first region of the plug-in bolt, while the other plug-in bolt or bolts have a first and a second region each having a substantially identical central axis.

Due to the eccentric arrangement of the second regions of the at least two plug-in bolts, the second regions of the plug-in bolts can approximate one another while maintaining the same distance between the first regions. The second regions can also be spaced apart from one another by the eccentric arrangement. For a given plug face, in particular due to the smaller distance of the central axes of the second regions from one another compared to the distance of the central axes of the first regions from one another, it can be achieved that heat can be dissipated as well as possible via the first regions. The spacing of the first regions results in a low accumulation of heat between the plug-in bolts. The recesses of the first regions can also be spaced apart as far apart from one another as possible, which further results in a spatial distribution of warm elements.

The central axes of the first regions and the second region of the at least two plug-in bolts can lie substantially in a common plane.

The central axes of the second regions can be at a smaller distance from one another than the central axes of the first regions of the at least two plug-in bolts.

The central axis of the first region and that of the second region can be parallel to one another. The two central axes can also be tilted relative to one another.

An eccentric arrangement of the second region on the first region enables in particular a relative positioning of the central axes of the two regions (the first and the second) to one another. In particular, part of an adaptation between two different plug-in geometries can be achieved in this manner, for example. One plug-in geometry can be connected on the side of the second regions, another on the side of the first region of the plug-in bolts. Different spacings between connection points on the sides of the first region and the second region can be enabled by an eccentric arrangement.

The geometric spacings within the plug connector can also be influenced by the eccentric arrangement of the second region on the first region. By means of the eccentric arrangement of the second region on the first region, the second region of a first plug-in bolt can be moved closer to or away from at least one other plug-in bolt without changing the relative position of the first regions of the plug-in bolts to one another. The same applies vice versa for the position of the second regions of the plug-in bolts. By an eccentric arrangement, the second region of a first plug-in bolt can for example be spaced as far as possible from the second plug-in bolt, in particular from the second region of the second plug-in bolt. The second region of a first plug-in bolt can also be brought as close as possible to the at least one further plug-in bolt of the plug connector.

Similarly, it is possible to vary the distance of the first regions from one another by the eccentric arrangement of the second region on the first region while keeping the distance between the first regions substantially constant. The first regions can also be approximated or spaced apart in this manner.

In a preferred embodiment, the second regions of the at least two plug-in bolts are each arranged eccentrically in the direction of the other plug-in bolt(s). In this way, for a given distance of the second regions from one another, the first regions are spaced apart as far apart from one another as possible. In other words, for a given distance of the first regions, the second regions have the smallest possible distance from one another.

The at least two plug-in bolts are spaced apart from one another. In particular, the plug-in bolts are spaced apart from one another substantially perpendicular to the longitudinal axis of at least one of the plug-in bolts.

The longitudinal axes of the plug-in bolts are oriented substantially parallel to one another. The plug-in directions of the plug-in bolts can also be substantially parallel to one another. The plug-in directions can also be tilted relative to one another.

The recess in the first region of a plug-in bolt can also be arranged eccentrically to the central axis of the first region in the first region of the plug-in bolt. In this way, similar to the eccentric positioning of the second region at the first region, an adaptation to a predetermined distance of connecting key bolts can be achieved. The distance between any elements positioned in the recess can also be adjusted. In particular, the recess of at least one plug-in bolt can be offset eccentrically outwards in the first region, so that it is at a greater distance from another plug-in bolt of the plug connector than it would be in a central arrangement.

The first and/or the second front faces of the plug-in pins can be substantially flush with one another in the longitudinal direction. The end faces can therefore be aligned with one another in a direction perpendicular to the longitudinal axis, central axis, and/or plug-in direction of at least one of the plug-in bolts. The plug-in bolts can also be offset relative to one another in the longitudinal direction.

The second region is adjacent to a further end face of the first region, which is different from the first end face. The further end face is arranged in the central region of the plug-in bolt. The end face can be substantially smooth. The edges of the further end face can also be rounded and/or flattened, for example. The further end face can also taper, in particular conically, in the direction of the second region, for example.

The second region of at least one of the plug-in bolts can be shaped as a pin. The second region may, for example, have a round cross section, an oval, elliptical, angular, in particular triangular, square, or polygonal, or otherwise shaped cross section. The cross section of the second region can be substantially constant along the longitudinal axis. The cross section of the second region can also vary. In particular, the cross section of the second region can increase towards the center region, for example.

An end face can represent the end of the plug-in bolt along the longitudinal axis. Part of the plug-in bolt can also protrude beyond the end face. For example, a guide tip can protrude beyond an end face of the plug-in bolt. In particular, the guide tip may have a protrusion, in particular a thickening and/or an indentation, in particular a circumferential thickening and/or indentation, for example so that a cap can be placed on it.

In particular, a cap made of a non-conducting material can be arranged on the plug-in bolt, in particular on its front end, in particular on the guide tip. In particular, this cap can be arranged in a force-fit and/or form-fit manner on the plug-in bolt, in particular on the guide tip. The cap can be made, for example, from plastics material, silicone, and/or another non-conductive material. In particular, the cap can have substantially the same cross section, at least in the transition to the plug-in bolt, as the region of the plug-in bolt adjacent to the cap. This prevents an edge at the transition between the cap and plug-in bolt.

A guide tip can be arranged in particular on the end face of the second region. A cap can also be arranged there.

The surface of the first region can be substantially smooth. The surface of the first region can also be structured. For example, the first region may have protrusions and/or indentations, in particular at least one groove, in particular an at least partially circumferential groove. In particular, the lateral surface of the first region can be structured. For example, this lateral surface can have at least one groove which is at least partially circumferential. In addition to the first end face and the further end face of the first region, here the lateral surface is a further surface which extends circumferentially to the longitudinal axis. A textured surface has the advantage of increased connection strength between the plug-in bolt and the housing.

The cross section of the first region and/or of the second region can be substantially constant along the longitudinal axis of the plug-in bolt. Small deviations, for example due to a structuring the surface, are included in this.

To ensure that the plug-in bolt has a good hold in the housing and, in particular, is protected against rotation about the longitudinal axis relative to the housing, it can be advantageous to design the cross section of the first region to deviate from a round shape. In particular, the first region may have at least one indentation and/or one protrusion extending at least partially along the longitudinal direction. For example, a groove can be provided, or a strip. Other protrusions such as individual rod-shaped protrusions and/or pot-shaped indentations are also possible. In particular, the cross section can also be angular in shape, for example triangular, quadrangular, pentagonal, polygonal, and/or star-shaped or otherwise shaped. Due to the fact that the cross section is not rotationally symmetrical at least in some regions, a rotation would be accompanied by a change in the cross section. The housing can thus effectively counteract a rotation.

In one embodiment, the cross section of the first region of a first plug-in bolt can be flattened on the side of the first region which faces the at least one other in the assembled state.

The prevention of rotations is especially important in the case of eccentrically arranged recesses in first regions and/or an eccentric arrangement of second regions on first regions. A rotation would change the connection geometry and in particular the distance between individual connections.

The cross section of the second region can be substantially constant. The cross section of the second region can also change along the longitudinal axis. In particular, the cross section in the central region can have an increased cross section in the transition to the first region. This increases the mechanical stability of the transition. An indentation, for example a circumferential groove, can also be provided in the central region. In particular, a seal, for example a sealing ring, can be provided around the second region, in particular in the region of the increased cross section, in particular in the circumferential groove.

The plug-in bolt can be formed in one piece. It is also possible for the plug-in bolt to be produced from a plurality of partial pieces, in particular from two partial pieces. For example, one partial pieces may substantially correspond to the first region and one partial pieces may substantially correspond to the second region.

In one embodiment, the at least two plug-in bolts of the plug connector are substantially identical in shape. In another embodiment, the plug-in bolts are constructed mirror-symmetrically to one another.

The housing fixes the at least two plug-in bolts to one another. For this purpose, the housing at least partially encloses the plug-in bolts. In particular, the housing can engage with the outer lateral surfaces of the first regions of the plug-in bolts. The lateral surfaces of the first regions provide a large access surface for the housing. Since the first region is preferably in contact with another current-carrying element via the recess, the lateral surface also does not fulfill an electrically conductive function and can be covered with the housing. In addition to the mechanical fixing of the plug-in bolts, this thus also serves to electrically insulate the first region. In particular, the housing serves to electrically insulate the plug-in bolts from one another.

The housing can be formed from a non-conductive material, in particular ceramic, glass and/or plastics material. Preferably, a high-temperature plastics material can be used. The housing can be in one piece. The housing can also be made up of several parts. The housing and/or its parts can be substantially rigid and substantially unchangeable in shape. It is also possible for the housing and/or its parts to be flexible. In particular, it is possible for a plurality of parts of the housing to be connected to one another in a movable and/or captive manner, for example by hinges.

The housing can be connected to the plug-in bolts. For example, the plug-in bolts can be inserted into the housing at recesses of the housing provided for this purpose. For this purpose, retaining means can be provided on the housing, for example projections on at least some of the edges of the openings of the recesses in the housing. It is also possible for the housing to be placed around the plug-in bolts in a multi-part design. For example, a plurality of parts of the housing can be placed around the plug-in bolts and can be connected to one another. For example, the parts can be screwed together. Retaining means on housing parts such as recesses and barbs, which can interlock to connect the housing parts, are also possible.

Retaining means can be provided for fastening the plug-in bolts in the housing. Examples of protrusions at the edges of the openings in the recesses of the housing have already been mentioned above. Further possibilities comprise protrusions, for example within the recess for the plug-in bolts, which can engage in protrusions provided on the lateral surface of the first regions of the plug-in bolts. Conversely, protrusions on the housing can engage in recesses on the lateral surfaces of the first regions of the plug-in bolts.

In a preferred embodiment, the housing around the plug-in bolts can be injection molded, cast or otherwise converted from a malleable consistency to a rigid consistency in direct contact with the plug-in bolts. In particular, a plastic housing can be injection-molded around the plug-in bolts. Curing of the housing around the plug-in bolts has the advantage that the housing fits snugly against the plug-in bolts, in particular on the lateral surfaces of the first regions of the plug-in bolts. This not only ensures a good hold, but also high thermal conductivity in the housing and thus a good ability to dissipate heat. In particular, if a structuring of the surface of the plug-in bolts is present in the regions in which the housing is applied onto the plug-in bolts, a very stable connection can be achieved.

The housing preferably rests substantially over the entire surface on the lateral surfaces of the first regions of the plug-in bolts. There is therefore direct contact between the housing and the plug-in bolts over a large part of the overlap between the housing and the plug-in bolts. In particular, the housing can engage in indentations on the plug-in bolt, in particular on the lateral surface of the first region of the plug-in bolt, for example grooves. Protrusions on the surface of the plug-in bolt also engage in indentations in the housing.

In particular, full-surface contact of the housing on the plug-in bolts, in particular on the lateral surfaces of the first regions of the plug-in bolts, can be achieved if the housing is cast, injection-molded or otherwise formed around the plug-in bolts.

As already mentioned above, the housing can have openings. These at least enable contact to be made with the recess in the end face of the first region of at least the plug-in bolts. An opening in the housing is also to be provided, which allows at least parts of the second region of the plug-in bolts to make contact. In one embodiment, the housing has an opening in the region of the first end face of at least one of the plug-in bolts. In particular, the first end face can be completely exposed by an opening of the housing. In one embodiment, the housing terminates substantially flush with the first end face of at least one plug-in bolt. It is also possible for the housing to project beyond the first end face in the longitudinal direction. The first end face can also substantially be completely covered by the housing, so that only the access for receiving at least one plug-in bolt remains. This can have the advantage that, after a connecting key bolt has been connected in the receptacle, few conductive surfaces are openly accessible.

The housing can also have, for at least one, preferably for all the plug-in bolts, an opening on the side of the corresponding plug-in bolt opposite the first end face. This allows the second region of the plug-in bolt to be contacted. As already shown above, a further end face of the first region can be identified, which is different from the first end face of the plug-in bolt. This is an end face which points toward the second region of the corresponding plug-in bolt to which the first region belongs. In some embodiments of the housing, this end face is also at least partially exposed through an opening in the housing. In particular, the housing can be substantially flush with the further end face of the first region. It is also possible for the housing to point at least partially beyond the further end face in the longitudinal direction, in the direction of the second region. It is also possible to cover the further end face of the first region substantially completely with the housing.

The housing can be designed to be fully solid. It is also possible that the housing has open spaces. This saves material and weight and minimizes the heat transfer path from the plug-in bolts to the surroundings. The housing surfaces that are in direct contact with the surroundings can serve as cooling surfaces. In particular, frame surfaces can be provided on the housing to support an otherwise minimal housing. For example, the plug-in bolts can each be enclosed by only one housing layer on their surface areas to be enclosed. However, this alone would probably not provide sufficient stability for the housing. In addition, frame surfaces can be provided on the housing to stabilize the housing, among other things. The frame surfaces can be part of the housing; in particular, the housing can be formed in one piece with frame surfaces. It is also possible to fasten the frame surfaces to the other housing parts, for example by gluing, welding, screwing and/or otherwise fastening them.

Frame surfaces can be formed from the same material as the housing. It is also possible to produce frame surfaces from a different material. For example, frame surfaces can be formed from a material with good thermal conductivity, such as a metal material. In addition to a high level of stability, this can achieve a particularly high ability to dissipate heat, for example by means of heat radiation.

Frame surfaces may be substantially flat and have substantially a single orientation. It is also possible to vary the spatial orientation of frame surfaces locally. For example, frame surfaces can be wave-shaped, zig-zag-shaped, irregularly variable in their orientation, or otherwise shaped differently from a flat surface.

In one embodiment, frame surfaces can be aligned substantially perpendicular to the longitudinal axis of the at least one plug-in bolt. Additionally or alternatively, frame surfaces can be aligned parallel to the longitudinal axis, for example in one or also in two surface orientations, which are perpendicular to one another, for example. A plurality of frame surfaces can be provided. Frame surfaces can have orientations and/or shapes differing from one another.

At least one frame surface can protrude beyond the rest of the housing, perpendicular to the longitudinal axis. In particular, this can be at least one frame surface which is itself aligned substantially perpendicular to the longitudinal axis of at least one of the plug-in bolts. Holes can be arranged in the frame surface. For example, two, three, four, or more holes can be arranged in the frame surface. In particular, the holes can be arranged in a region of the frame surface that protrudes beyond the rest of the housing. By way of example, screws, rivets, barbs, or other fastening means can be passed through the holes, which can be used to fasten the plug connector to a further element. The holes can be at least partially reinforced, for example with metal inserts. This means that the plug connector can be used, for example, as a translating adapter with a particularly high current carrying capacity and the possibility of heat dissipation and heat capacity.

In particular, a seal can be arranged on a frame element. For example, a seal can be arranged on a frame surface that makes contact with the charging socket. For example, a seal can be arranged circumferentially around the plug-in bolts. In particular, a seal can be arranged on at least one or more frame surfaces which protrude beyond the housing perpendicular to the longitudinal axis of the plug-in bolts. For example, a seal can be formed from an elastic material such as silicone, plastic, rubber or another sealing material. In particular, materials that are heat-resistant and/or fireproof and/or have high heat conductivity are preferable.

As already mentioned above, the housing can protrude beyond the further end face of the first region of at least one plug-in bolt, which points in the direction of the second region, in particular in the direction of the second region. In particular, a frame surface can protrude beyond the further end face in the direction of the second region. For example, the frame surface can be arranged between the at least two plug-in bolts. In particular, the frame surface can be arranged substantially parallel to the longitudinal direction of at least one of the plug-in bolts. The frame surface designed in this way can serve to insulate the plug-in bolts from one another in the region of the second region. The frame surface of this type can also serve as a spacer with respect to further elements which approximate the further end face of the first region from the direction of the second region. The frame surface can project beyond the rest of the housing in the longitudinal direction. The frame surface may serve to insulate the at least two plug-in bolts from one another, in particular to increase the path of a leakage current between the plug-in bolts, in particular along a surface of the housing.

A charging socket according to the invention can be connected to a plug connector according to the invention. In particular, the plug connector can be arranged at least partially in the charging socket, in particular in the second receptacle of the charging socket.

In particular, the plug connector can be arranged in the charging socket in such a way that at least one of the at least two second regions of the plug-in bolts is arranged at least partially in the receptacle of the charging socket. In particular, the plug connector can be in contact with the charging socket circumferentially around at least one of the plug-in bolts, for example on a bearing region of the charging socket. The housing of the plug connector can make direct contact with the charging socket and/or a seal can be arranged between the two, via which the plug connector makes indirect contact with the charging socket. The charging socket and connecting plug can be connected to one another by force-fit and/or form-fit. In particular, the housing of the plug connector can be connected to the charging socket, in particular to the housing of the charging socket. In particular, the two can be screwed together.

A further aspect is a system according to claim 21.

The system comprises a charging socket according to the invention and a connecting part according to the invention. The connecting key bolt of the connecting part is arranged in the recess of the charging socket in a force-fit and/or form-fit manner.

In particular, a retaining means such as a screw can be passed through the through-hole in the case of a through-hole in the connecting key bolt. By means of the screw, the connecting key bolt and the recess of the charging socket can be held against one another with a contact pressure. This reduces the transition resistance between the two elements.

The Joule heat generated by ohmic losses at the transition between the connecting key bolt and the recess can be conducted and dissipated via the busbar, among other things.

The subject matter is explained in more detail below with reference to drawings showing exemplary embodiments. In the drawings:

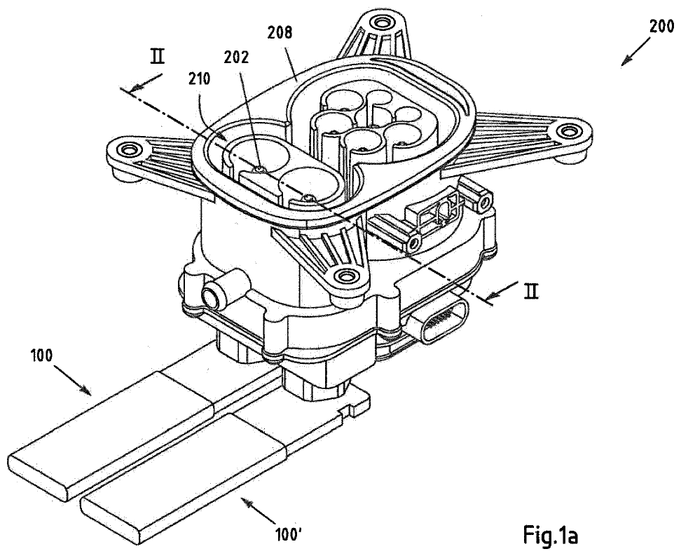

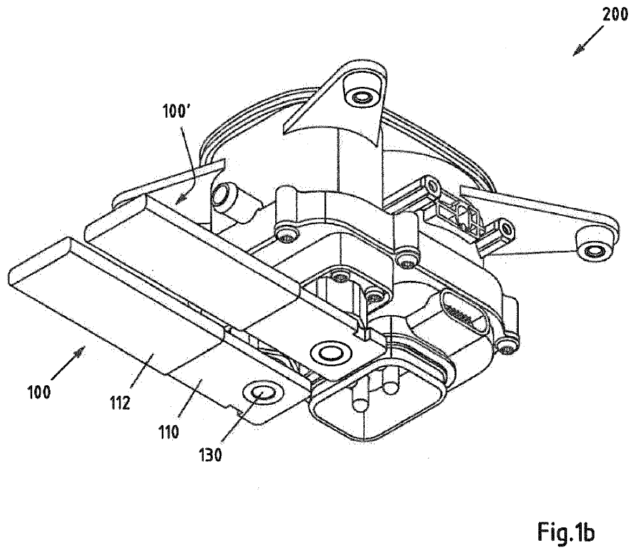

FIG. 1a-b shows an isometric view from two viewing angles of a charging socket according to the invention and a connecting part according to the invention, according to an exemplary embodiment;

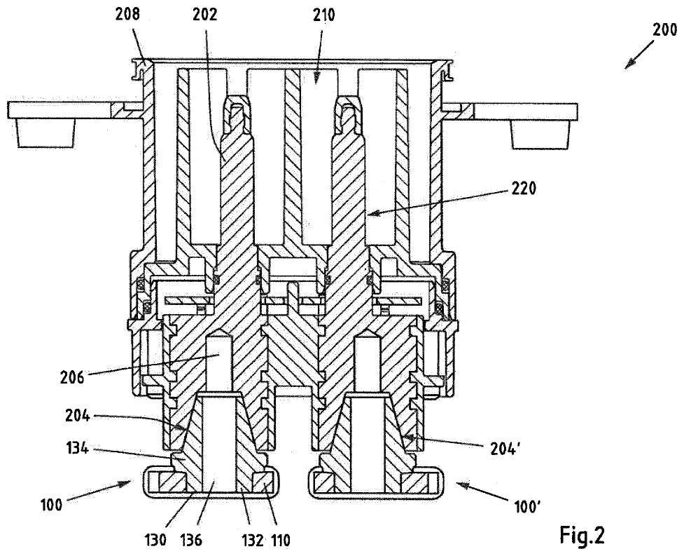

FIG. 2 shows a sectional view of a charging socket according to the invention and a connecting part according to the invention, according to an exemplary embodiment;

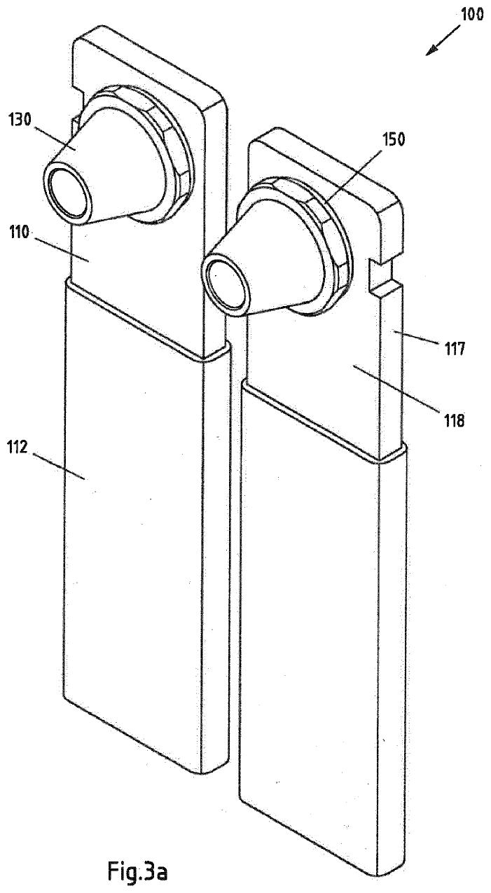

FIG. 3a, b show an isometric view from two viewing angles of two connecting parts according to the invention, according to an exemplary embodiment;

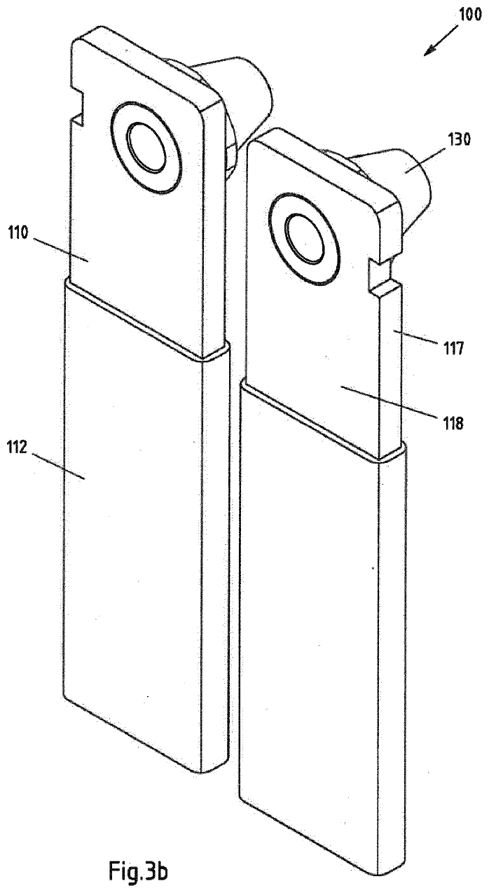

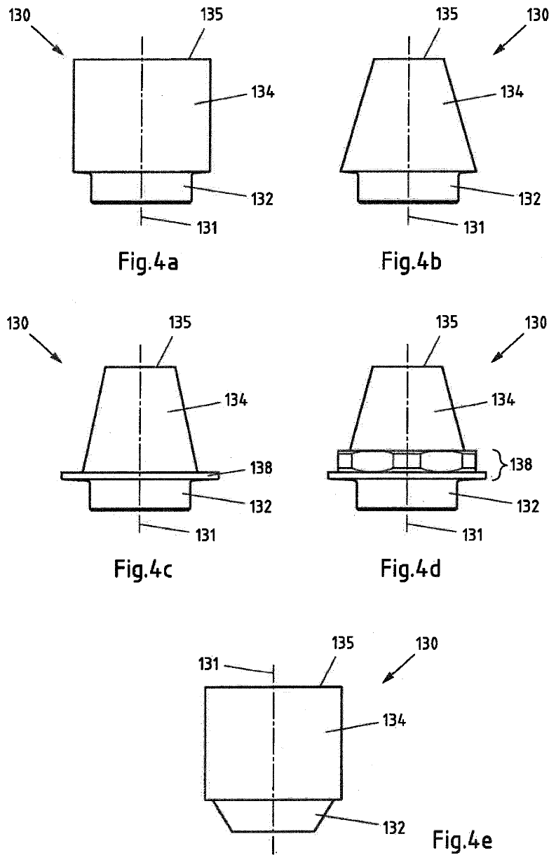

FIG. 4a-e show connecting key bolts according to exemplary embodiments, in side view;

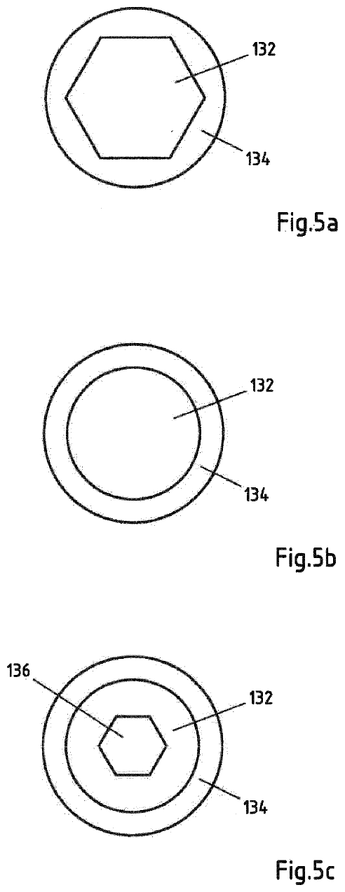

FIG. 5a-c show connecting key bolts according to exemplary embodiments, in plan view;

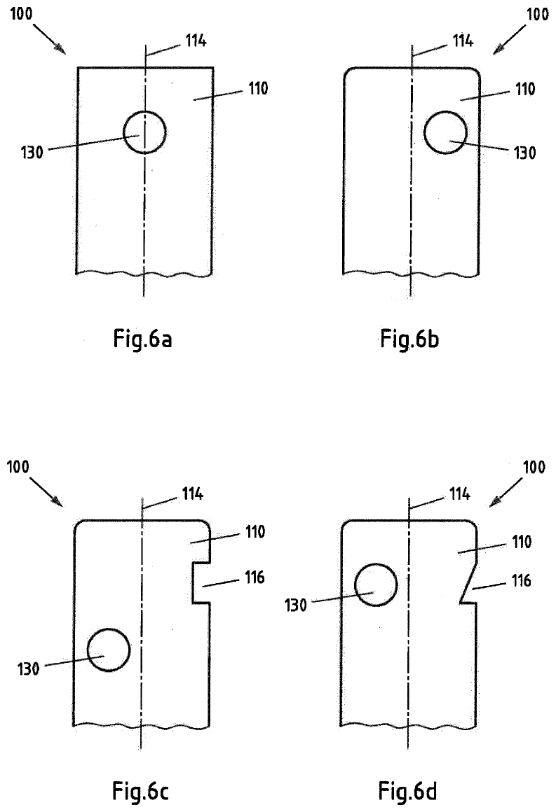

FIG. 6a-d show the connecting part with various connecting key bolt positions according to exemplary embodiments, in plan view;

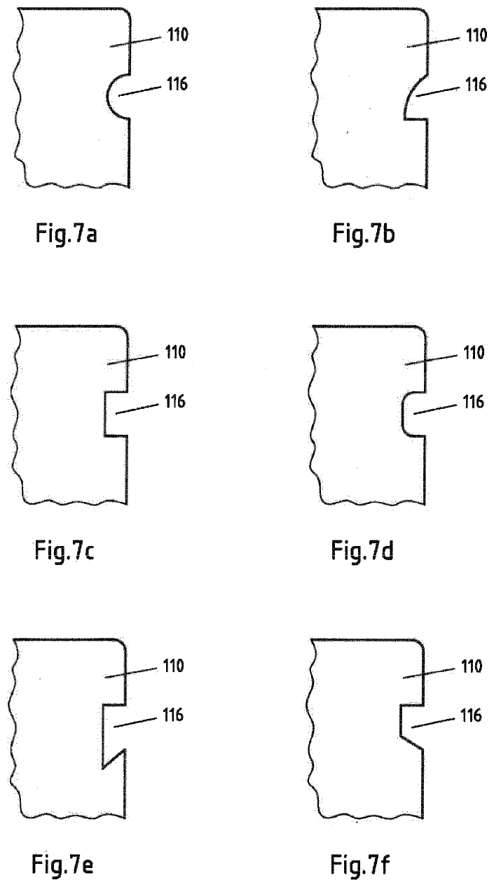

FIG. 7a-f show a busbar with a side recess according to exemplary embodiments, in plan view;

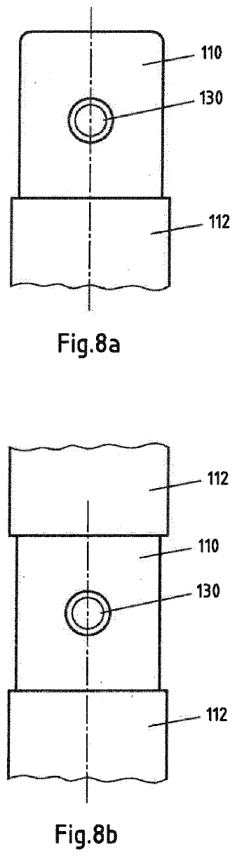

FIG. 8a, b show a connecting part as an end tap and as a center tap according to exemplary embodiments, in plan view.

FIG. 1a, b shows a charging socket 200 in a sectional view. This charging socket comprises a contact pin 202 in a receptacle 210 for a charging plug. The charging socket can comprise a housing 208.

A connecting part 100 is also shown. This connecting part comprises a busbar 110. This busbar can have an insulation 112. A connecting key bolt 130 is located on the busbar 110. This bolt is arranged in an opening of the busbar 110, preferably connected to thereto in a material-fit manner.

FIG. 2 shows a section along line III in FIG. 1a through a charging socket 200 according to the invention having two connecting parts 100, 100′ according to the invention. On the front side, the charging socket 200 comprises a receptacle 210 and a contact pin 202 which is arranged inside the receptacle 210. The contact pin 202 is formed by parts of the plug-in bolt 220. Furthermore, a housing 208 is provided, the opening of which forms the receptacle 210. A recess 204 is arranged on the rear side of the charging socket 200. A blind hole 206 is located in this recess. The connecting parts 100, 100′ are arranged in the recesses 204, 204′. A connecting part 100 comprises a busbar 110 and a connecting key bolt 130. The latter can be divided into a joining region 132 and a contact region 134. A through-hole 136 extends through the connecting key bolt 130.

FIG. 3a, b shows a plurality of views of a connecting part 100 according to the invention. This connecting part comprises a busbar 110 and a connecting key bolt 130 with through-hole 136. The busbar 110 has two narrow sides 117 and two wide sides 118. Connecting key bolt 130 and busbar 110 can be connected in a material-fit manner, for example by means of a weld 150. The connecting key bolt 130 can protrude beyond the busbar 110 with its joining region 132. Also, as shown, the joining region 132 of the connecting key bolt 130 may be substantially flush with the wide side 118 of the busbar 110.

FIG. 4a-e are examples of designs of connecting key bolts 130. These designs comprise a joining region 132 and a contact region 134. These regions lie one behind the other along a longitudinal axis 131 of the connecting key bolt 130. The contact region 134 can have a larger diameter than the joining region 132. The contact region 134 can have an end face 135.

The contact region 134 can extend in a straight manner, as shown in FIG. 4a.

As shown in FIG. 4b, the contact region 134 may be tapered, in particular conically tapered, with increasing distance from the joining region 132.

The connecting key bolt can also comprise a collar 138 which may protrude laterally beyond the joining region 132 and in some cases also beyond the contact region 134, perpendicular to the longitudinal axis 131 of the connecting key bolt 130. See FIG. 4c.

In FIG. 4d, a collar 138 with a partially angular cross section can be seen. This cross section can be used, for example, for engagement with friction welding tools.

A further possible design is shown in FIG. 4e, in which the joining region 132 is tapered with increasing distance from the contact region 134.

FIG. 5a-c show exemplary plan views of connecting key bolts 130 along the longitudinal axis 131. In FIG. 5a, the joining region 132 is angular in shape, in particular hexagonal, while the contact region 134 has a round cross section.

FIG. 5b shows an embodiment with a substantially round cross section of each of the first region 132 and the second region 134.

Finally, FIG. 5c shows the possibility of designing the through-hole 136 so as to deviate from a round cross section, in particular with an angular shape. This can also be used to attach a friction welding tool.

FIG. 6a-d show various arrangements of the connecting key bolt 130 on a busbar 110 of the connecting part 100. The central axis 114 of the busbar 110 can be used as a reference here. The connecting key bolt 130 can be located centrally on this central axis 114 (FIG. 6a) or can be offset eccentrically to one side of the busbar 110 (FIG. 6b). If the busbar 110 has a side recess 116, the position of the connecting key bolt 130 can also be determined relative to this recess. The side recess 116 can thus be offset along the central axis 114, for example closer to the end of the busbar 110, as shown in FIG. 6c. The connecting key bolt 130 and the side recess 116 of the busbar 110 can also be at substantially the same height along the central axis 114 and/or have approximately the same distance from the end of the busbar 110, see FIG. 6d.

FIG. 7a-f shows different shapes of side recesses 116. These side recesses can be arranged, for example, as a semicircle on the side of the busbar 110. Here, the edge of the side recess 116 initially extends substantially perpendicular to the side edge of the busbar 110 into the busbar, and then describes an arc from the busbar 110.

Alternatively, for example, is possible a four-part circle as a side recess 116 (FIG. 7b), a rectangle (FIG. 7c), a rectangle with rounded corners (FIG. 7d), a side recess with an undercut (bottom) (FIG. 7e) or, for example, a side recess with an edge extending perpendicular to the side edge (top) and an edge extending at an angle to the side edge of the busbar 110 (bottom) in FIG. 7f.

As shown in FIG. 8a, the connection element 100 according to the invention can be designed as an end tap of a busbar 110. The connecting key bolt 130 can also be arranged in a central region of a busbar 110 (FIG. 8b), for example surrounded on both sides by insulation 112.

1. A connecting part, comprising:
at least one busbar
at least one connecting key bolt arranged on the busbar, wherein
the connecting key bolt has a joining region extending starting from a first end face to a central region, and a contact region extending starting from a second end face to the central region, and
the connecting key bolt is arranged with the joining region in an opening in the busbar and connected to the busbar in a material-fit manner,
wherein
the contact region is conically tapered, and
the connecting key bolt has a through-hole.

2. (canceled)

3. (canceled)

4. (canceled)

5. The connecting part according to claim 1,
wherein
the opening of the busbar is formed as a through-hole.

6. (canceled)

7. The connecting part according to claim 1,
wherein
the busbar has at least one rounded corner in an end region of the busbar.

8. (canceled)

9. The connecting part according to claim 1,
wherein
the busbar has a side recess.

10. (canceled)

11. The connecting part according to claim 1,
wherein
the connecting key bolt is arranged decentrally in relation to the central axis of the busbar.

12. The connecting part according to claim 1,
wherein
the connecting key bolt has a through-hole that extends substantially in the direction of the longitudinal axis of the connecting key bolt and/or in the direction of the surface normal of the wide side of the busbar.

13. The connecting part according to claim 1,
wherein
the through-hole has a cross section which deviates from a round shape, in particular an elliptical, angular, in particular triangular, quadrangular, polygonal or otherwise shaped cross section.

14. The connecting part according to claim 1,
wherein
the lateral surface of the joining region is substantially cylindrical in shape.

15. The connecting part according to claim 1,
wherein
the lateral surface of the joining region is at least partially connected to an inner lateral surface of the opening of the busbar in a material-fit manner.

16. The connecting part according to claim 1,
wherein
the lateral surface of the contact region is substantially conical in shape.

17. The connecting part according to claim 1,
wherein
the joining region of the connecting key bolt has a smaller diameter than the opening of the busbar, and/or the diameter of the joining region of the connecting key bolt substantially corresponds to that of the opening of the busbar.

18. The connecting part according to claim 1,
wherein
the contact region of the connecting key bolt has at least in part a larger diameter than the opening of the busbar.

19. The connecting part according to claim 1,
wherein
the contact region of the connecting key bolt has a collar which is at least partially connected to the busbar in a material-fit manner.

20. The connecting part according to claim 1,
wherein the joining region of the connecting key bolt is longer in the direction of the longitudinal axis of the connecting key bolt and/or in the direction of the surface normal on the wide side of the busbar than the thickness of the busbar in this direction.

21. The charging socket according to claim 23 wherein the connecting key bolt is arranged in the recess at least in a form-fitting and/or force-fitting manner.

22. The charging socket according to claim 23,
wherein a screw is guided through the through-hole of the connecting key bolt and in particular holds the connecting key bolt in the recess of the charging socket.

23. Charging socket having a front side and a rear side facing away from the front side, having
a receptacle for a charging plug arranged on the front side,
a plug-in bolt arranged within the receptacle, extending starting from the front side toward the rear side,
wherein the plug-in bolt has a first region extending starting from a first end face to a central region, and a second region extending starting from a second end face to the central region, wherein the first region extends starting from the rear side in the direction of the receptacle, and the second region extends into the receptacle, wherein the plug-in bolt has a recess on its first end face,
a connecting part according to claim 1 arranged on the rear side,
wherein the connecting key bolt is arranged with the contact region at least partially in the recess.
